(19) United States
(12) Patent Application Publication
(10) Pub. No.: US 2008/0098628 A1
(43) Pub. Date: May 1, 2008

(54) Ornamental gift card holder

(76) Inventor: Sherwin Geitner, Glenview, IL (US)

Correspondence Address: Charles F. Meroni, Jr, P.O. Box 309, Barrington, IL, 60011, US

(21) Appl. No.: 11/582,226

(22) Filed: Oct. 17, 2006

(51) Int. Cl. G09F 1/00

(52) U.S. Cl. 40/124.06

(57) ABSTRACT

An ornamental gift card holder ornamentally presents a gift card to a gift recipient. The gift card holder comprises an anterior card-framing portion, a posterior card-retaining portion, and a card-receiving slot. The card-framing and card-retaining portions are substantially planar, and the card-receiving slot extends intermediate the card-framing and card-retaining portions in parallel relation thereto. The slot comprises opposing closed and open ends, and is sized and shaped for frictionally retaining the gift card. The receivable gift card may be received via the open end and stoppable via the closed end. The card-framing portion comprises a card-display window for enabling anterior viewing of the anterior portion of the card. The closed end positions the card in centered relation relative to the card-display window. The card-retaining portion functions to posteriorly retain the gift card in the card-receiving slot.

### BACKGROUND OF THE INVENTION

1. Field of the Invention

The present invention generally relates to a device for ornamentally presenting a gift card to a card recipient. More particularly, the present invention relates to an ornamental gift card holder or card-holding ornament for receiving, retaining, and presenting a gift card to a card recipient in an ornamental manner.

2. Description of the Prior Art

Ornamental display devices for displaying two and three dimensional elements are known in the prior art. While typically taking the form of traditional or conventional Christmas ornaments and the like, other shapes are also known. Some of the more pertinent prior art relating to ornamental display devices and the like are briefly described hereinafter.

U.S. Pat. No. 3,440,128 ('128 patent), which issued to Kubilius, for example, discloses a Christmas Ornament. The '128 patent teaches a personalized Christmas tree ornament comprising a hollow plastic shell vertically split to produce a front portion and a back portion each having adjoining edges, said front and a back portion each having adjoining edges, said front portion being composed of transparent plastic and having fastening means fixably to engage it to said back portion, said back portion being composed of opaque plastic having a highly reflective bright coloring on the convex side, having a highly reflective silverized coating on the concave side and having means spaced along the perimeter of said split edge fixably to engage said fastening means of said front portion, with means at the top of said hollow plastic shell defining an eye through which a hook may be passed, a photographic fastening means positioned in the bottom section of said back portion, a photograph of an individual or a family group fixably engaged by said photograph fastening means so that the photograph may be viewed through said front portion when said front and back portions are fixably engaged.

U.S. Pat. No. 3,624,939 ('939 patent), which issued to Gossard, discloses a Novelty Container for Photographs. The '939 patent teaches a pair of housing parts that are hinged together to define an enclosure for a plurality of photographs. A retainer on one end of the housing parts receives peripheral apertures in the photographs to maintain them in planes parallel to the axis on the hinge.

U.S. Pat. No. 3,694,648 ('648 patent), which issued to Yates, discloses an Ornamental Device. The '648 patent teaches an ornamental device including a housing, means on the housing for hanging the housing on a suitable support, means within the housing for holding an element to be viewed, means within the housing for illuminating the element, and means carried by the housing for permitting viewing of the illuminated element. The device may be spherical and simulate a Christmas tree ornament. The element to be viewed may comprise a photographic transparency.

U.S. Pat. No. 4,173,667 ('667 patent), which issued to Rusch, discloses a Christmas Ornament and Kit for Making the Same. The '667 patent teaches a kit for making an ornament which can be supported on a stand or hung from a Christmas tree or the like includes a pair of transparent preferably hemispherical hollow housing-forming members lockable into confronting relation to form a transparent housing with a vertical line of juncture therebetween to provide an unobstructed view into the housing from opposite sides thereof. The housing-forming members have complimentary confronting narrow neck-forming portions between which a tiny hand rod can be mounted. A hook-receiving cap member is provided which frictionally fits over the neck-forming portions of the housing-forming members to lock the same together. The kit also includes an ornamental article or articles to be mounted in a predetermined position initially in one of the members before the other member is fitted thereover. The ornamental article may be a greeting card supportable in a vertical position by hanging the same on the hang rod. The greeting card is formed from a greeting card blank forming part of the kit and having a pressure sensitive adhesive on one side covered by a removable backing sheet. The kit further includes a template to trace a line on a suitable photograph to be trimmed along the line so the photograph fits on the pressure sensitive side of the greeting card. An annular Christmas wreath border-forming element and ornamental braid are also incorporated in the kit respectively for ornamenting and covering the margins of the photograph supported on the greeting card and for covering the juncture line between the housing-forming members.

U.S. Pat. No. 4,224,364 ('364 patent), which issued to Hunt, discloses an Ornamental Display Container. The '364 patent teaches an ornamental display container comprising a pair of hollow housing sections and a connecting ring for releasably joining the housing sections together to define a closed container. In one embodiment of the invention the assembled housing is a ball and the connecting ring comprises a circular rib with opposed outwardly extending flanges extending from opposite sides of the rib to frictionally receive and retain the housing sections. An inner portion of the rib projects inwardly from the flanges to define an annular support for two and three dimensional objects selectively displayed on the annular support.

U.S. Pat. No. 4,592,936 ('936 patent) which issued to Ferguson, discloses an Ornamental Article with Internal Display Bracket. The '936 patent teaches a decorative ornamental object suitable for use as a Christmas ornament, Valentine heart, Easter egg or other holiday or occasion-related article. The ornamental object comprises a hollow housing having an aperture for viewing the inside of the housing. The present invention provides for mounting a picture, personalized message, and other two- and three-dimensional elements inside the housing which may be viewed through the viewing aperture. These display elements may be easily placed in or removed from the ornamental object. In addition, the ornamental object may be used as a gift container.

U.S. Pat. No. 6,732,459 ('459 patent), which issued to Clark, discloses a Greeting Card with Gift Card Holder. The '459 patent teaches a gift package comprising a greeting card and an integrated gift card holder sized and shaped to receive a gift card such as that issued by various retail stores and restaurants, to provide a convenient, efficient and attractive way to present a recipient with a greeting card suited for the occasion. The gift package also includes a cover which covers a portion of the gift card holder. The gift card holder is movable between a first position relative to the cover when the greeting card is in a closed state, and a second position relative to the cover when the greeting card is in an opened state. When a gift card is placed in the gift card holder, at least a substantial portion of the gift card is displayed to a recipient from behind the cover when the greeting card is opened.

U.S. Pat. No. 7,024,807 ('807 patent), which issued to Street, discloses a Greeting Card with Scannable Gift Card. The '807 patent teaches a combination greeting card and gift card with a coded information portion and is provided to be sold and delivered to a recipient as a unit. The greeting card includes preprinted indicia preferably corresponding to a particular occasion such as a birthday, holiday, graduation or other celebratory event. The coded information portion of the gift card preferably includes a PIN number or a scannable portion which, when an account in a remote computer corresponding to the coded information and the gift card is activated, enables the holder of the gift card to obtain goods or services by access to credit corresponding to the card from a remote database. The gift card is initially temporarily coupled to the greeting card by adhesive, tabs and slits, or a mechanical fastener, and concealed when the front and rear panels of the greeting card are in a closed, substantially parallel orientation.

It may be seen from an inspection of the foregoing disclosures that many devices known to date suffer from several problems which detract from their use. Many of the devices, while properly function to display a message or picture, do not allow for the ornamental presentation of an easily manually removable gift item such as a gift card or the like. Certain of the prior art require illumination means to properly enable viewing of the displayed element, and still other prior art require either partial or complete disassembly of the display device to do so.

From an inspection of the foregoing disclosures as well as from a consideration of the art in general, it will be seen that the prior art does not teach or otherwise disclose a substantially planar gift card display device, which device comprises an internal slot sandwiched intermediate opposing substantially planar ornamental surfaces, and which slot functions to snugly receive and retain the gift card for ornamental display through a card display window integrally formed in the viewable front portion of the display device. The prior art thus perceives a need for such a device insofar as the device of the present disclosure provides distinct advantages over prior or current ornamental gift card display or presentation devices, as set forth in more detail hereinafter.

### SUMMARY OF THE INVENTION

Accordingly, the prior art perceives a need for a moldable, low-cost card-holding ornament construction or ornamental gift card holder, which card-holding ornament functions to enable eased manual removal of a gift card without disassembly of the device and that affords clear and easy viewing of the displayed element. Further, it is an object of the present invention to provide an ornamental card display device suitably shaped for presentment during holidays or other festive occasions such as Christmas, Easter, Valentine's Day, anniversaries, and birthdays. Still further, it is an object of the invention to provide an ornamental card-holding display device suitable for receiving, retaining, and ornamentally presenting a gift as embodied in a gift card. Additional objects and advantages of this invention will become apparent from the following descriptions.

The ornamental gift card holder of the present invention essentially comprises an anterior card-framing portion, a posterior card-retaining portion, a card-receiving slot, a longitudinal ornament axis, and a latitudinal ornament axis. The longitudinal and latitudinal ornament axes orthogonally intersect one another at an ornament center. The card-receiving slot is preferably sandwiched intermediate the card-framing and card-retaining portions and comprises opposing closed slot and open slot ends. The card-receiving slot is sized and shaped for receiving and retaining a gift card much akin to conventional credit or debit cards.

In this last regard, it is contemplated that the card receivable in the card-receiving slot may preferably comprise an anterior card face, a posterior card face, and an outer card periphery, the outer card periphery being bound by opposing top and bottom edges and opposing insert and removal edges. The insert edge is receivable via the open slot end and mechanically stoppable via the closed slot end. Notably, the card-framing portion comprises a card-display window for enabling anterior viewing of the anterior card face when the card is received in the card-receiving slot. The closed slot end functions to position the insert and removal edges equidistant from the longitudinal ornament axis and further functions to position the anterior card face in centered relation relative to the card-display window. The card-retaining portion essentially functions to posteriorly retain the card in the card-receiving slot.

The card-holding ornament of the present invention may be said to further comprise a decorative, anteriorly viewable outer holder periphery, which may be in the form of a traditional circular or rounded ornament, or any suitable shape so as to accentuate the card display window. The card-display window is preferably substantially centered relative to the outer holder periphery so that the outer holder periphery essentially functions as certain framing means for the displayed gift card thereby ornamentally accentuating the card-display window. In the preferred embodiment, the card-display window may be defined by a card-viewing aperture, the card-viewing aperture for enabling the user to manually contact the anterior card face via the card-framing portion. It is contemplated that by enabling manual contact of the anterior card face via the card-viewing aperture, users or card recipients may more easily manually remove the card from the display device. Further, it is contemplated that the card-viewing aperture may function to retain the gift card in the card-receiving slot from the anterior direction insofar as the aperture may preferably comprise an inner aperture periphery lesser in magnitude than the outer card periphery for providing mechanical card retainment structure.

The card-retaining portion may preferably comprise a removal edge-exposing portion and a flip stand assembly. It is contemplated that the edge-exposing portion may well enable a user to manually contact the removal edge for enhancing one's ability to remove the gift card from the card-receiving slot. Further, it is contemplated that the flip stand assembly may well function to enable the user or gift recipient to stand the gift card holder upon a support surface. In this regard, it will be seen that the flip stand assembly is pivotally attached to the card-retaining portion, and extendable therefrom for enabling selective upright orientation of the card-holding ornament for card display purposes.

### BRIEF DESCRIPTION OF THE DRAWINGS

Other features of my invention will become more evident from a consideration of the following brief description of patent drawings:

FIG. 1 is an anterior or front plan view of the ornamental gift card holder of the present invention showing a circular outer holder periphery juxtaposed adjacent a gift card and depicting directional receipt and removal of the gift card via diagrammatic arrows.

FIG. 2(a) is an open slot end edge view of the ornamental gift card holder shown in FIG. 1.

FIG. 2(b) is a bottom edge view of the gift card shown in FIG. 1.

FIG. 3 is a posterior or back plan view of the ornamental gift card holder of the present invention showing a circular outer holder periphery juxtaposed adjacent a gift card and depicting directional receipt and removal of the gift card via diagrammatic arrows.

FIG. 4(a) is a second edge view (opposite the open slot end edge view) of the ornamental gift card holder shown in FIG. 3.

FIG. 4(b) is an insert edge view of the gift card shown in FIG. 3.

FIG. 5 is a side view of the ornamental gift card holder of the present invention showing the open slot end of the card-receiving slot and flip stand in an outwardly pivoted, holder-supporting position.

FIG. 5(a) is an enlarged fragmentary side view of a portion of the ornamental gift card holder shown in FIG. 5 depicting (1) a portion of the open slot end of the card-receiving slot, (2) a card edge-exposing portion of the card-retaining portion, and (3) a portion of the flip stand.

FIG. 6 is a frontal perspective view of the ornamental gift card holder of the present invention.

FIG. 7(a) is an anterior or front plan view of a first alternative ornamental gift card holder of the present invention showing a snowflake-shaped outer holder periphery.

FIG. 7(b) is an anterior or front plan view of a second alternative ornamental gift card holder of the present invention showing a gift package profile-shaped outer holder periphery.

FIG. 8 is an anterior or front plan view of the card-framing portion of the ornamental gift card holder of the present invention showing a card-display window.

FIG. 9 is a top edge view of the card-framing portion of the ornamental gift card holder of the present invention.

FIG. 10 is a left edge view of the card-framing portion of the ornamental gift card holder of the present invention shown in FIG. 8

FIG. 11 is a frontal perspective view of the card-framing portion of the ornamental gift card holder of the present invention.

FIG. 12 is a posterior or back plan view of the card-retaining portion of the ornamental gift card holder of the present invention showing a flip stand assembly and card edge-exposing portion.

FIG. 13 is a top edge view of the card-retaining portion of the ornamental gift card holder of the present invention.

FIG. 14 is a left edge view of the card-retaining portion of the ornamental gift card holder of the present invention shown in FIG. 12.

FIG. 15 is a frontal perspective view of the card-retaining portion of the ornamental gift card holder of the present invention.

FIG. 16 is a plan view of the flip stand assembly of the ornamental gift card holder of the present invention.

FIG. 17 is a top edge view of the flip stand assembly of the ornamental gift card holder of the present invention.

FIG. 18 is a left edge view of the flip stand assembly of the ornamental gift card holder of the present invention shown in FIG. 16.

FIG. 19 is a frontal perspective view of the flip stand assembly of the ornamental gift card holder of the present invention.

### DETAILED DESCRIPTION OF THE PREFERRED EMBODIMENT(S)

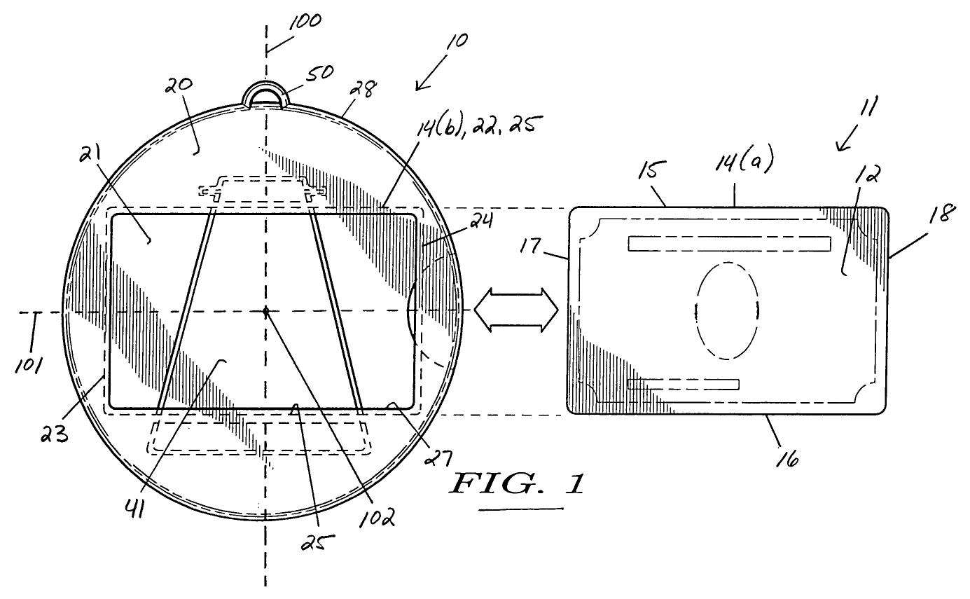

Referring now to the drawings with more specificity, the preferred embodiment of the present invention generally concerns an ornamental gift card holder, a card-holding ornament or a card display device 10 as generally illustrated and referenced in FIGS. 1, 2(a), 3, 4(a), and 5-7(b). It is contemplated that the gift card holder or card display device of the present invention may well function to receive, hold, and ornamentally present a substantially planar, rectangular gift card, such as a credit card, a debit card, a gift certificate type card, or similar other card 11 as generally illustrated and referenced in FIGS. 1, 2(b), 3, 4(b), and 6.

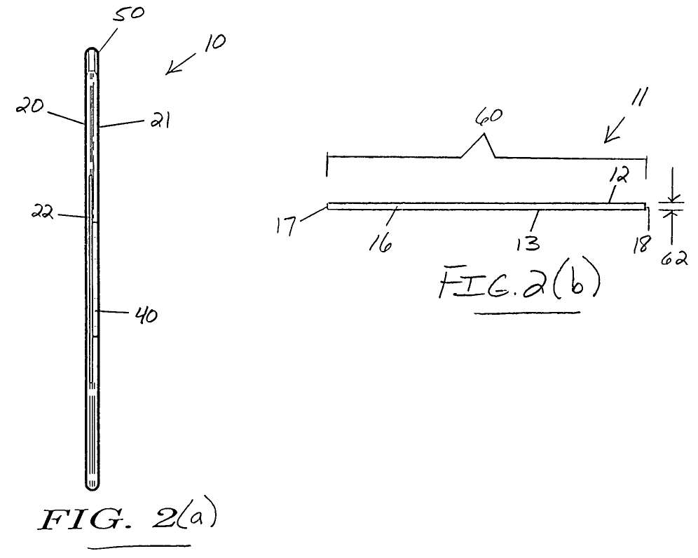

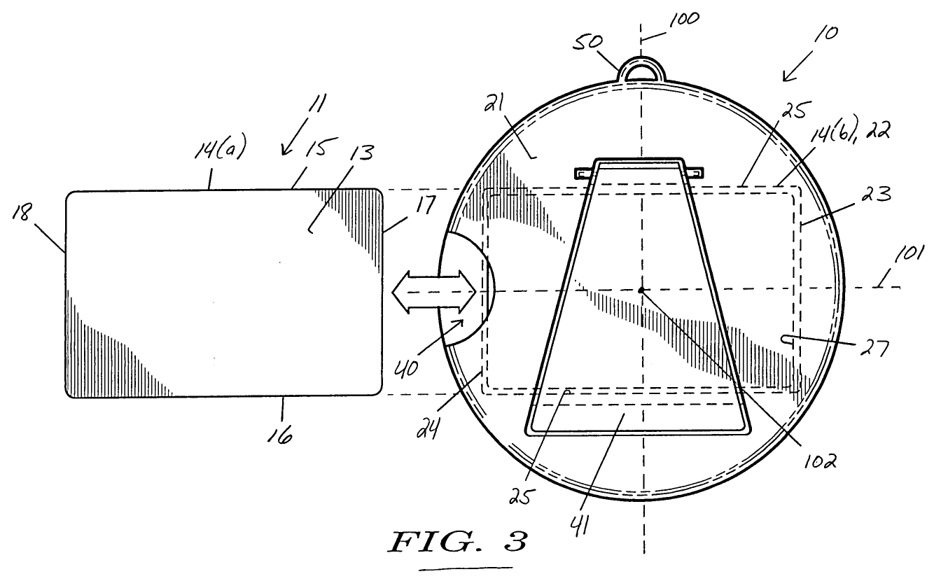

The card 11 that may be received, held, and ornamentally presented by the present invention may be said to essentially comprise an anterior card face 12 as referenced in FIGS. 1, 2(b), 4(b), and 6; a posterior card face 13 as referenced in FIGS. 2(b), 3, and 4(b); and an outer card periphery, which outer card periphery is generally referenced in FIGS. 1 and 3 in solid lines at 14(a) and broken lines at 14(b). It will be understood form a consideration of the noted figures that broken lines 14(b) depict the preferred spatial orientation of the outer periphery of card 11 when card 11 is received and held for ornamental presentation within display device 10. It should be further understood from a consideration of the noted figures that the outer card periphery, being preferably rectangular in structure, may be being defined by a top edge 15 as referenced in FIGS. 1, 3, and 4(b); a bottom edge 16 as referenced in FIGS. 1, 2(b), 3, and 4(b); an insert edge 17 as referenced in FIGS. 1, 2(b), 3, and 4(b); and a removal edge 18 as referenced in FIGS. 1, 2(b), and 3.

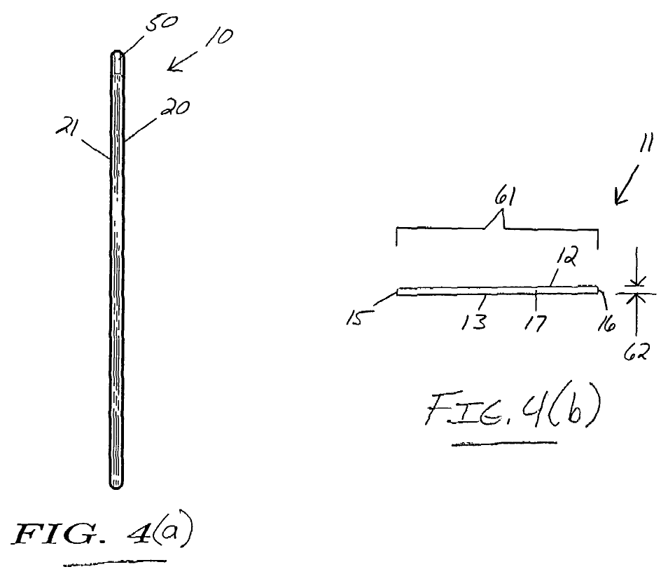

It is contemplated that the gift card holder or card-holding ornament of the present invention is designed to frictionally receive and hold a card of the typical credit card structural specifications or dimensions. In this regard, it may be noted that a typical credit card is generally about 8.6 centimeters (3.375 inches) long (as generally referenced at numeral 60 in FIG. 2(b)) by about 5.4 centimeters (2.25 inches) wide (as generally referenced at numeral 61 in FIG. 4(b)) and on the order of about 0.5-1 millimeter(s) (0.04-0.0625 inches) in thickness (as generally referenced at numeral 62 in FIGS. 2(b) and 4(b)). The card 11 may be preferably constructed of synthetic resin or laminated in order to be suitably rigid as is well known to those skilled in the art, and as noted in U.S. Pat. No. 7,024,807. Similar to the card 18 of the '807 patent, the gift card or card 11, usable in combination with the present invention, may well further include certain scannable coded portions, which portions may include certain identifying code information corresponding to each respective gift card.

In this last regard, it is contemplated that a coded portion 46 may be provided by a magnetically coded strip, or alternatively by optically scannable bar coding or a coded chip carrying a transponder which supplies a signal when electronically interrogated or a transmitter which sends a signal to a receiver. The anterior card face or surface 12 and/or posterior card face or surface 13 of the card 11 may be printed with certain indicia, which indicia may provide information as to the account holder who carries the credit from which the recipient may obtain goods or services, or further information as to the manner of use of the card 11 as is well known in the art and as further disclosed in the '807 patent.

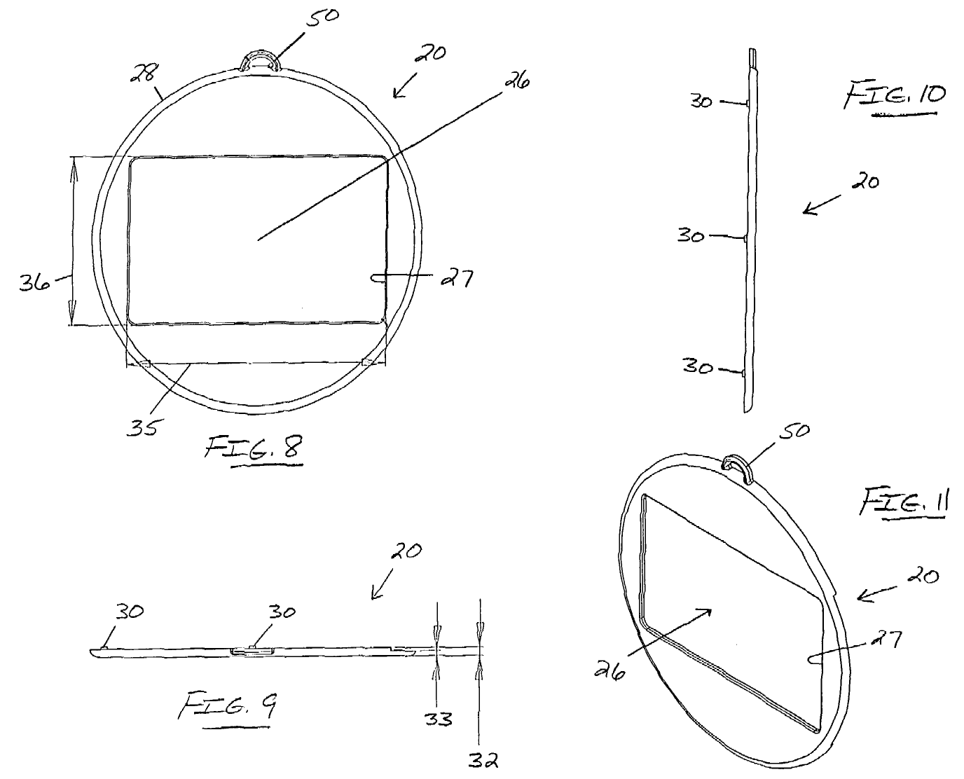

The preferred gift card holder or card-holding ornament 10 of the present invention may be said to comprise a longitudinal holder, ornament, or device axis 100 as referenced in FIGS. 1, 3, 7(a), and 7(b); a latitudinal holder, ornament, or device axis 101 as referenced in FIGS. 1, 3, 7(a), and 7(b); an anterior card-framing portion 20 as illustrated and referenced in FIGS. 1, 2(a), 4(a), and 5-11; a posterior card-retaining portion 21 as illustrated and referenced in FIGS. 1, 2(a), 3, 4(a), 5, 5(a), 6, and 12-15; and a card-receiving slot 22 as depicted and referenced in FIGS. 1, 2(a), 3, 5, and 5(a). It may be seen from an inspection of the noted figures that the longitudinal and latitudinal holder axes 100 and 101 preferably orthogonally intersect at a holder center, ornament center, or display center 102 as referenced in FIGS. 1, 3, 7(a), and 7(b).

The card-framing portion 20 and the card-retaining portion 21 are each preferably substantially planar as may be seen from a comparative inspection of FIGS. 2(a), 4(a), 5, 6, 9, 10, 13, and 14. Each of the portions 20 and 21 are preferably constructed from molded polymer materials having decorative or ornamental colorant(s) and are substantially rigid for effecting a low-cost, durable, card-holding medium. As may be understood from a further comparative inspection of FIGS. 1, 3, 5, and 5(a), the card-receiving slot 22 extends, or is sandwiched, intermediate the card-framing and card-retaining portions 20 and 21 in substantially parallel relation thereto and preferably comprises a closed end 23 as referenced in FIGS. 1 and 3; an open end 24 as referenced in FIGS. 1, 3, 5, 5(a), and 6; and upper and lower card-guiding tracks 25, the latter of which have been specifically referenced in FIGS. 1 and 3. As earlier indicated, the card-receiving slot 22 is preferably sized and shaped for removably retaining the received gift card or card 11 in snug relation as, for example, by wedged or frictional engagement with surrounding structures.

In this last regard, it should be therefore noted that certain specifications of the anterior card-framing portion 20, the posterior card-retaining portion 21, and the card-receiving slot 22 may be critical to the practice of the invention given the typical specifications of cards 11 contemplated for use in combination with the present invention. In this regard, the reader is directed to FIGS. 8-11 (which figures specifically depict certain structural specifications of the anterior card-framing portion 20) and FIGS. 12-15 (which figures specifically depict certain structural specifications of posterior card-retaining portion 21).

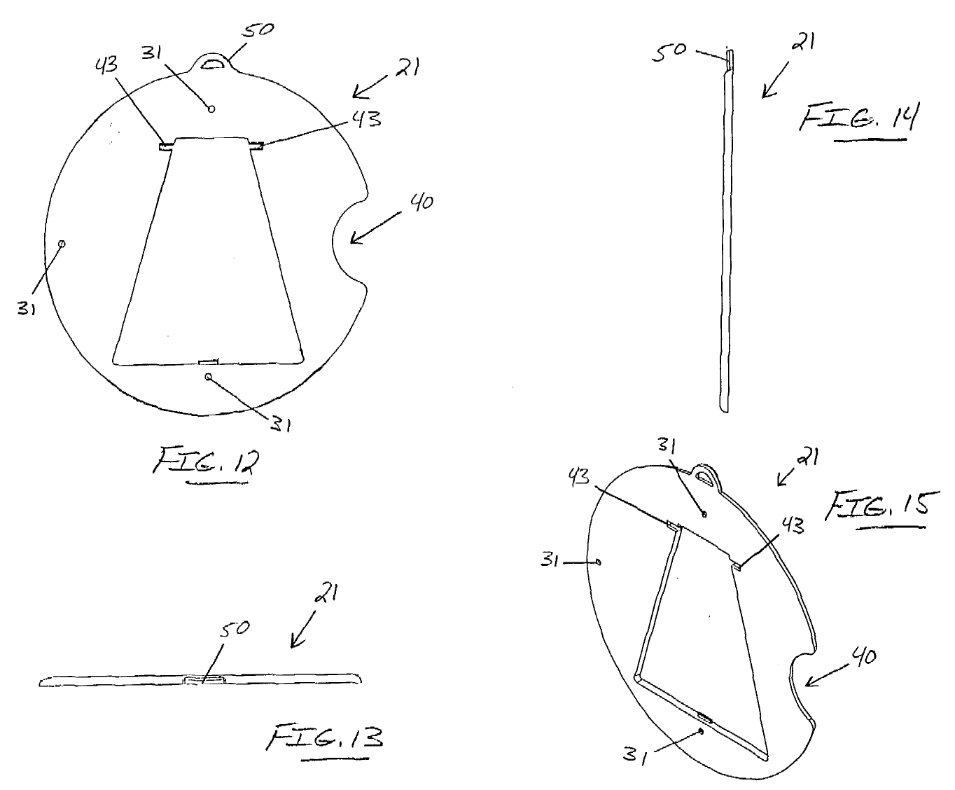

It will be seen that card-framing portion 20 is preferably matable with card-retaining portion 21 via certain tabs or male structure 30 of card-framing portion 20 as specifically illustrated and referenced in FIGS. 9 and 10. Tabs or male structure 30 are matable with apertures or female structure 31 of card-retaining portion 21 as further illustrated and referenced in FIGS. 12 and 15. It will be understood that card-framing portion 20 may be preferably mated with card-retaining portion 21 via certain tab-aperture structure as herein noted, but other engagement means otherwise known in the applicable arts may function to achieve similar excellent results. Further, tabs or male structure 30 need not be formed as part of card-framing portion 21, and apertures or female structure 31 need not be formed as part of card-retaining portion 21 as specifically illustrated and referenced. The noted structures have been illustrated and referenced as such for simplicity in drawing to convey the basic concept, which, it is contemplated, is well known within the art(s).

Central to the practice of the present invention is card-receiving slot 22. When mated, card-framing portion 20 and card-retaining portion 21 are cooperable to form card-receiving slot 22, the latter of which is essentially formed by situating a card-shaped structural void 34 on the posterior portion of card-framing portion 20 against card-retaining portion 21 via the matable structures earlier described. Given an overall preferred structural thickness of card-framing portion 20 of about 0.10 inch as referenced at 32 in FIG. 9, the structural void 34 may be considered to be on the order of about 0.04 inches, the structure in anterior adjacency to the void having a preferred thickness of about 0.06 inches as further referenced at 33 in FIG. 9. Thus, when card-framing portion 20 is mated with card-retaining portion 21, card-receiving slot 22 comprises a preferred thickness on the order of about 0.04 inches for snugly or frictionally receiving and retaining card 11.

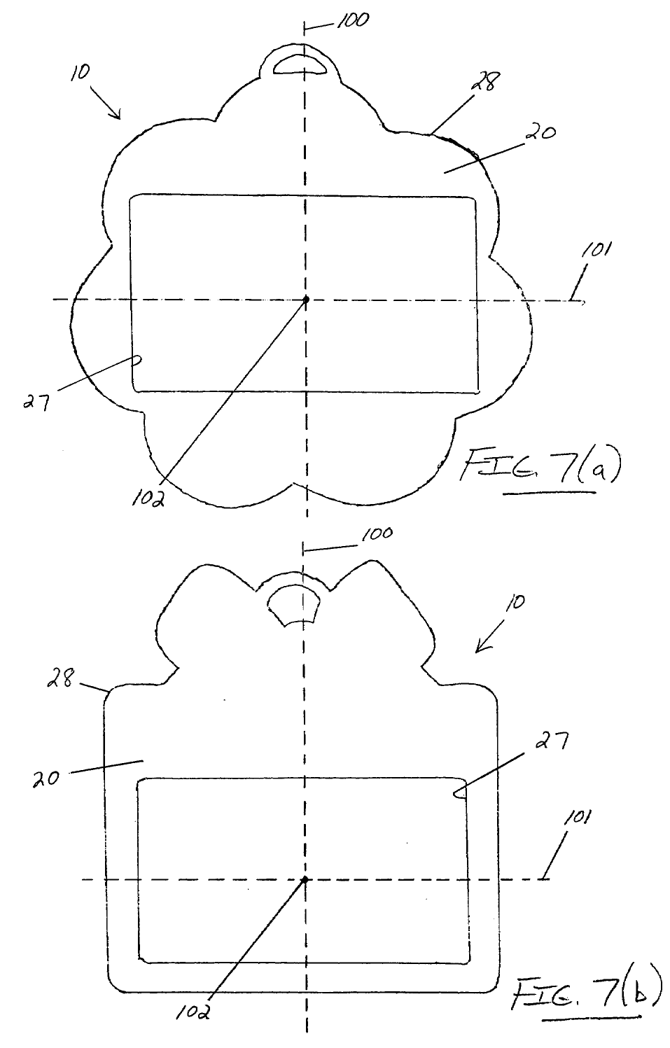

The insert edge 17 if card 11 is thus receivable via the open end 24, guidable by the card-guiding tracks 25, and mechanically stoppable via the closed end 23. Notably, the card-framing portion 20 preferably comprises a card-display window 26 as further illustrated and referenced in FIGS. 8 and 11. Preferably defined by a view-enabling aperture, the card-display window 26 essentially functions to enabling viewing of the anterior card face 12 from an anterior viewpoint. Secondarily, however, the card-viewing aperture may well function to enable the user to manually (i.e. with one's fingers) contact the anterior card face 12 via the card-framing portion 20. Further, it may be well understood from an inspection of FIGS. 1, 3, 6-8, and 11 that the card-viewing aperture preferably comprises an inner aperture periphery 27, which inner aperture periphery 27 is lesser in magnitude than the outer card periphery as referenced at 14(a) and 14(b) for anteriorly retaining the gift card or card 11 in the card-receiving slot 22, as for example, by frictionally and mechanically engaging the anterior card face 12.

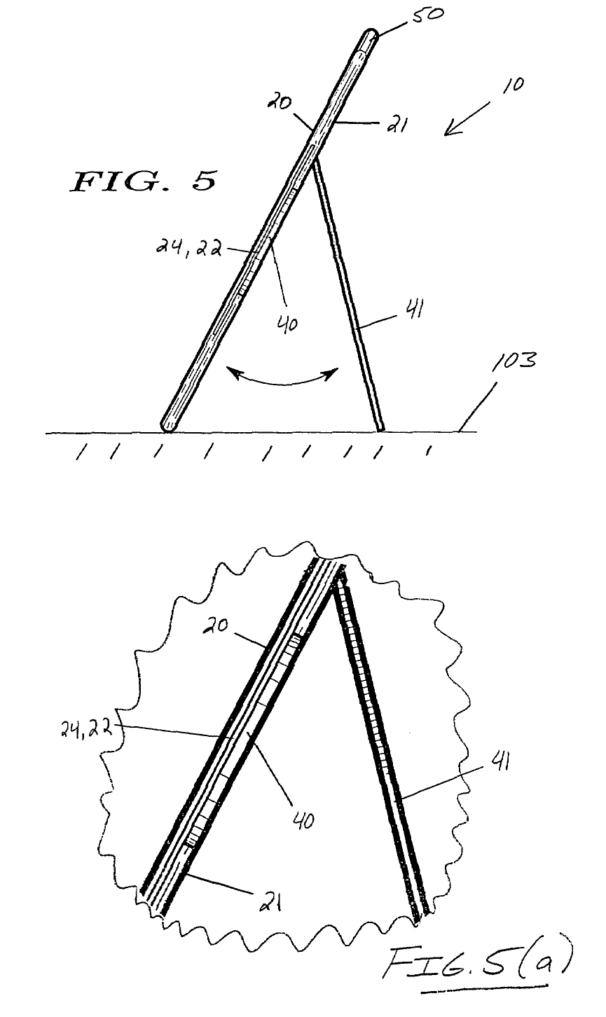

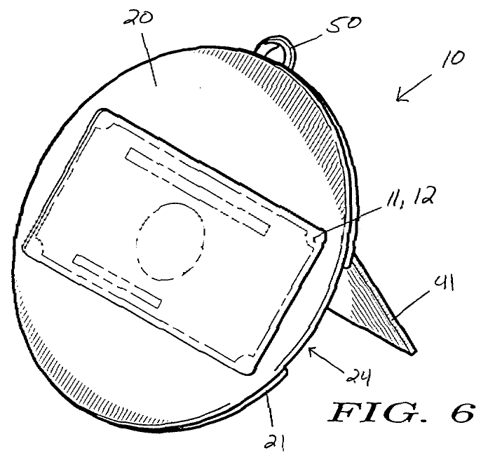

In this last regard, it may be seen from an inspection of FIG. 8 that the inner aperture periphery 27 may be preferably defined by having a length dimension of about 3.24 inches as referenced at 35 and a width dimension of about 2.01 inches as referenced at 36. Together, the noted length and width may well function to prevent card 11 from becoming anteriorly displaced. Further, the inner aperture periphery 27 may well function to further frame the anterior card face 11 for enhancing the ornamental delivery or presentation of gift card or card 11 as may be generally seen from an inspection of FIG. 6.

Moreover, it is contemplated that an anteriorly viewable outer holder periphery 28 may function to center and/or accentuate the card-display window 26 or aperture as generally referenced in FIGS. 1, and 7(a)-8. In this regard, it may be seen from an inspection of FIGS. 1 and 8 versus FIGS. 7(a) and 7(b) that any number of anterior plan view type outlines for outer holder periphery 28 are contemplated, including round or circular (as depicted in FIGS. 1 and 8); flower-shaped (as depicted in FIG. 7(a)); or gift package shaped (as depicted in FIG. 7(b)). Other contemplated shapes of this sort may include, but are not limited to snowflake-shapes, gingerbread man-shapes, snowman-shapes, balloon-shapes, etc. In this regard, it is contemplated that the outer holder periphery 28 may be preferably sized and shaped in any event for ornamentally accentuating the card-display window 26.

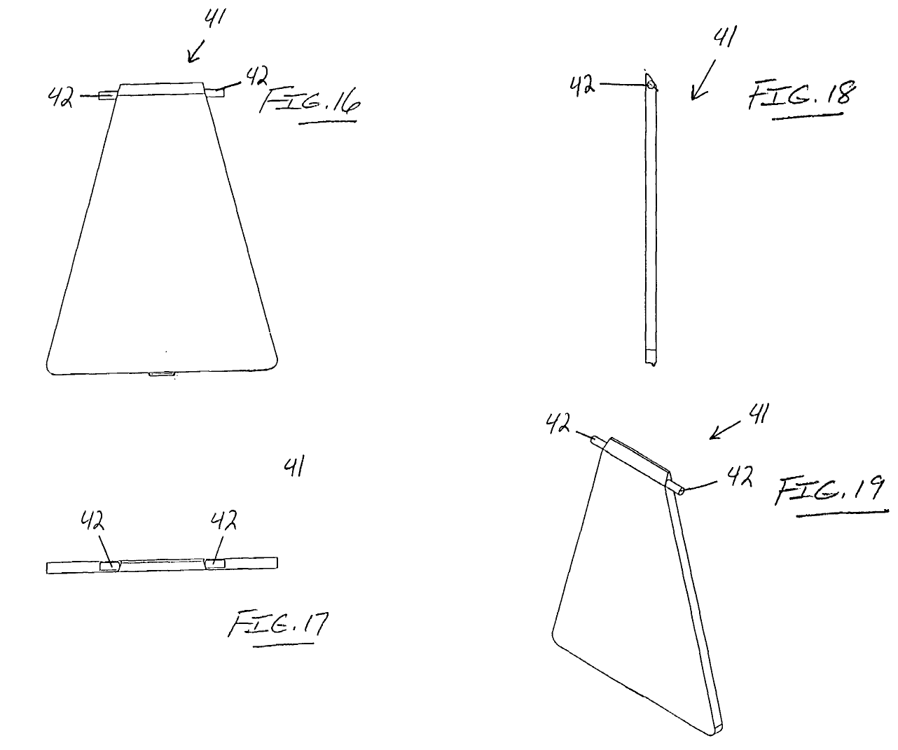

The card-retaining portion 21 may be said to preferably further comprise a removal edge-exposing portion or card edge-exposing portion 40 as illustrated and referenced in FIGS. 2(a), 3, 5, 5(a), 12, and 15; and a flip stand assembly 41 as illustrated and referenced in FIGS. 1356, and 16-19. It is contemplated that the removal edge or card edge-exposing portion 40 may well function to enable a user to more easily manually (i.e. with one's fingers) contact the removal edge 18 or posterior card face 13 for removing the gift card or card 11 from the card-receiving slot 22. In this regard, it will be seen that the portion 40 may preferably comprise a certain radius of curvature or be sized and shaped for allowing one's finger tip or thumb tip to contact the edge 18 for removing the card 11 from the slot 22.

The flip stand assembly 41 is preferably pivotally attached to the card-retaining portion 21 via tabs or male structure 42 (as illustrated and referenced in FIGS. 16-19, which male structure 42 is insertable into female structure, apertures, or grooves 43 formed in card-retaining portion 21 as illustrated and referenced in FIGS. 12 and 15. It is contemplated that the flip stand assembly 41 and the inferior most portion of outer holder periphery 28 may well cooperably function to enable a user to stand the gift card holder or card display device 10 upon a substantially planar support surface 103 as generally depicted in FIG. 5.

The closed end 23 preferably functions to position the opposing insert and removal edges 17 and 18 of card 11 equidistant from the longitudinal holder axis 100, and the card-guiding tracks 25 preferably function to position the top and bottom card edges 15 and 16 equidistant from the latitudinal holder axis 101. Further, the closed end 23 and the card-guiding tracks 25 function to position the anterior card face 12 in centered relation relative to the card-display window 26. The card-retaining portion 21 essentially functions to posteriorly retain the gift card or card 11 in the card-receiving slot 22, as for example, by frictionally and mechanically engaging the posterior card face 13. Certain means for hanging the gift card holder 10 from a holder support structure are further contemplated, which means may be defined by a loop-like structure 50 integrally formed at the superior most portion of the card-framing portion 20 and/or the card-retaining portion as illustrated and referenced in FIGS. 1, 2(a), 3, 4(a), 5-8, 11, 12, and 15.

While the above descriptions contain much specificity, this specificity should not be construed as limitations on the scope of the invention, but rather as an exemplification of the invention. For example, the present invention may be said to essentially teach or contemplates a card display device, which card display device comprises an anterior card-framing portion, a posterior card-retaining portion, and a card-receiving slot. The card-receiving slot being sandwiched intermediate the card-framing and card-retaining portions and comprising opposing closed and open slot ends and opposing card-guiding tracks, the card-receiving slot for receiving and retaining a card, the card comprising an anterior card face, a posterior card face, and an outer card periphery, the card being insertable into the card-receiving slot via the open slot end, the card being positionable via the closed slot end and, the card-framing portion comprising a card-display window, the card-display window for enabling anterior viewing of the anterior card face, the closed slot end and the card-guiding tracks for positioning the anterior card face in centered relation relative to the card-display window, the card-retaining portion for posteriorly retaining the card in the card-receiving slot.

The card display device may preferably comprise a longitudinal device axis and a latitudinal device axis, the longitudinal and latitudinal device axes orthogonally intersecting at a device or display center. The closed slot end and card-guiding tracks may thus function to position the card such that a card center is intersected by a select device axis, the select device axis being selected from the group consisting of the longitudinal device axis and the latitudinal device axis. Preferably, however, the closed slot end and card-guiding tracks function to position the card such that the card center coincides with the device or display center.

Accordingly, although the invention has been described by reference to a number of preferred embodiments, it is not intended that the novel apparatus be limited thereby, but that modifications thereof are intended to be included as falling within the broad scope and spirit of the foregoing disclosure, the following claims and the appended drawings.

I claim:

1. An ornamental gift card holder, the gift card holder for ornamentally presenting a substantially planar, rectangular gift card, the gift card comprising an anterior card face, a posterior card face, and an outer card periphery, the outer card periphery being defined by a top edge, a bottom edge, an insert edge, and a removal edge, the gift card holder comprising:
a longitudinal holder axis, a latitudinal holder axis, an anterior card-framing portion, a posterior card-retaining portion, and a card-receiving slot, the longitudinal and latitudinal holder axes orthogonally intersecting at a holder center, the card-framing and card-retaining portions being substantially planar, the card-receiving slot extending intermediate the card-framing and card-retaining portions in parallel relation thereto and comprising opposing closed and open ends, the card-receiving slot being sized and shaped for frictionally retaining the gift card, the insert edge being receivable via the open end and stoppable via the closed end, the card-framing portion comprising a card-display window, the card-display window for enabling anterior viewing of the anterior card face, the closed end for positioning the insert and removal edges equidistant from the longitudinal holder axis and for positioning the anterior card face in centered relation relative to the card-display window, the card-retaining portion for posteriorly retaining the gift card in the card-receiving slot.

2. The gift card holder of claim 1 comprising an anteriorly viewable outer holder periphery, the card-display window being centered relative to the outer holder periphery, the outer holder periphery being sized and shaped for ornamentally accentuating the card-display window.

3. The gift card holder of claim 2 wherein the card-display window is defined by a card-viewing aperture, the card-viewing aperture for enabling the user to manually contact the anterior card face via the card-framing portion.

4. The gift card holder of claim 3 wherein the card-viewing aperture comprises an inner aperture periphery, the outer card periphery being greater in magnitude than the inner aperture periphery, the inner aperture periphery thus for anteriorly retaining the gift card in the card-receiving slot.

5. The gift card holder of claim 2 wherein the card-retaining portion comprises a removal edge-exposing portion, the removal edge-exposing portion enabling a user to manually contact the removal edge for removing the gift card from the card-receiving slot.

6. The gift card holder of claim 2 wherein the card-receiving slot positions the top and bottom card edges equidistant from the latitudinal holder axis.

7. The gift card holder of claim 2 comprising a flip stand assembly, the flip stand assembly being pivotally attached to the card-retaining portion, the flip stand assembly and the outer holder periphery for enabling a user to stand the gift card holder upon a substantially planar support surface.

8. The gift card holder of claim 1 comprising means for hanging the gift card holder from a holder support structure.

9. A card-holding ornament, the card-holding ornament comprising a longitudinal ornament axis, a latitudinal ornament axis, an anterior card-framing portion, a posterior card-retaining portion, and a card-receiving slot, the longitudinal and latitudinal ornament axes orthogonally intersecting at an ornament center, the card-receiving slot being sandwiched intermediate the card-framing and card-retaining portions and comprising a closed slot end and an open slot end, the card-receiving slot for receiving and retaining a card, the card comprising an anterior card face, a posterior card face, and an outer card periphery, the outer card periphery being bound by opposing top and bottom edges and opposing insert and removal edges, the insert edge being receivable via the open slot end and stoppable via the closed slot end, the card-framing portion comprising a card-display window, the card-display window for enabling anterior viewing of the anterior card face, the closed slot end for positioning the insert and removal edges equidistant from the longitudinal ornament axis and for positioning the anterior card face in centered relation relative to the card-display window, the card-retaining portion for posteriorly retaining the card in the card-receiving slot.

10. The card-holding ornament of claim 9 comprising an anteriorly viewable outer holder periphery, the card-display window being centered relative to the outer holder periphery, the outer holder periphery being sized and shaped for ornamentally accentuating the card-display window.

11. The card-holding ornament of claim 9 wherein the card-display window is defined by a card-viewing aperture, the card-viewing aperture for enabling the user to manually contact the anterior card face via the card-framing portion.

12. The card-holding ornament of claim 11 wherein the card-viewing aperture comprises an inner aperture periphery, the outer card periphery being greater in magnitude than the inner aperture periphery, the inner aperture periphery thus for anteriorly retaining the gift card in the card-receiving slot.

13. The card-holding ornament of claim 9 wherein the card-retaining portion comprises a removal edge-exposing portion, the removal edge-exposing portion enabling a user to manually contact the removal edge for removing the gift card from the card-receiving slot.

14. The card-holding ornament of claim 9 wherein the card-receiving slot positions the top and bottom card edges equidistant from the latitudinal holder axis.

15. The card-holding ornament of claim 9 comprising a flip stand assembly, the flip stand assembly being pivotally attached to the card-retaining portion, the flip stand assembly and the outer holder periphery for enabling a user to stand the gift card holder upon a substantially planar support surface.

16. A card display device, the card display device comprising an anterior card-framing portion, a posterior card-retaining portion, and a card-receiving slot, the card-receiving slot being sandwiched intermediate the card-framing and card-retaining portions and comprising opposing closed and open slot ends and opposing card-guiding tracks, the card-receiving slot for receiving and retaining a card, the card comprising an anterior card face, a posterior card face, and an outer card periphery, the card being insertable into the card-receiving slot via the open slot end, the card being positionable via the closed slot end and, the card-framing portion comprising a card-display window, the card-display window for enabling anterior viewing of the anterior card face, the closed slot end and the card-guiding tracks for positioning the anterior card face in centered relation relative to the card-display window, the card-retaining portion for posteriorly retaining the card in the card-receiving slot.

17. The card display device of claim 16 comprising a longitudinal device axis and a latitudinal device axis, the longitudinal and latitudinal device axes orthogonally intersecting at a device center, the closed slot end and card-guiding tracks for positioning the card such that a card center is intersected by a select device axis, the select device axis being selected from the group consisting of the longitudinal device axis and the latitudinal device axis.

18. The card display device of claim 17 wherein the closed slot end and card-guiding tracks function to positioning the card such that the card center coincides with the device center.

19. The card display device of claim 16 wherein the card-display window is defined by a card-viewing aperture, the card-viewing aperture for enabling the user to manually contact the anterior card face via the card-framing portion.

20. The card display device of claim 19 wherein the card-viewing aperture comprises an inner aperture periphery, the outer card periphery being greater in magnitude than the inner aperture periphery, the inner aperture periphery thus for anteriorly retaining the card in the card-receiving slot.

21. The card display device of claim 16 wherein the card-retaining portion comprises a card edge-exposing portion, the card edge-exposing portion enabling a user to manually contact the card thereby enabling manual card removal from the card-receiving slot.

22. The card display device of claim 16 comprising a flip stand assembly, the flip stand assembly being pivotally attached to the card-retaining portion, the flip stand assembly for enabling a user to stand the card display device upon a substantially planar support surface.
